(19) United States
(12) Patent Application Publication
(10) Pub. No.: US 2021/0350223 A1
(43) Pub. Date: Nov. 11, 2021

(54) DIGITAL CONTENT VARIATIONS VIA EXTERNAL REACTION

(71) Applicant: INTERNATIONAL BUSINESS MACHINES CORPORATION, Armonk, NY (US)

(72) Inventors: Christian Eggenberger, Wil (CH); Frederik Frank Flöther, Schlieren (CH); Shikhar Kwatra, Durham, NC (US); Stefan Ravizza, Wallisellen (CH)

(21) Appl. No.: 16/868,627

(22) Filed: May 7, 2020

(51) Int. Cl. G06N 3/08; G06N 3/04

(52) U.S. Cl. CPC G06N 3/08; G06N 3/0454

(57) ABSTRACT

A method for performing an iteration of an output of a trained GAN may be provided. The method comprises receiving an object as input for the GAN, determining a set of features of the input by the generator adversarial network, generating, by the GAN, at least one modification to one feature of the set of features of the object, generating as output of the GAN the received object as a basis, and the generated modification building a modified object, capturing a feedback signal, and receiving the feedback signal as input by the GAN in a feedback loop for a next iteration. Moreover, the method comprises repeating the determination of a set of features, the generation of at least one modification, the generation of the output and the caption of the feedback signal in the next iteration, wherein as object the modified object is used as the object.

### BACKGROUND

### Field of the Invention

The invention relates generally to a modification of a digital object, and more specifically, to a computer-implemented method for performing an iteration of an output of a trained generator adversarial network. The invention relates further to a related reaction-enabled digital content creator system, and a computer program product.

### RELATED ART

Machine learning (ML) and artificial intelligence (AI) remain strong industry trends. These systems are deployed in almost every area of information technology (IT). New developments appear in very short cycles on the hardware side as well as on the software side. The technical community differentiates between supervised learning, semi-supervised learning, and unsupervised learning. One necessary ingredient for unsupervised learning is constant feedback from the output of the machine learning system to a mechanism allowing an autonomous adaption of the parameters of the machine learning system.

One instrument of such an approach is reinforcement learning (RL) that concerns the behavior of software agents that act in an environment in order to maximize some notion of reward. Thereby, the agent acts based on its state and knowledge/information about potential rewards and/or penalties. The technique has been redefined by, for instance, introducing a discount factor that may determine how far the agent should look into the future. Recently, this machine learning technique has become increasingly popular.

One of the tools used for reinforcement learning are generative adversarial networks (GANs). The network of this class of machine learning systems is adapted to learn to generate from a training distribution through a two player game. The two opponents or adversaries are a generator unit and a discriminator unit. These two adversaries are in constant battle throughout the training process. The generator is used to, e.g., generate real-looking images and the discriminator's job is to identify which one is a fake. The adversaries are in constant battle as the generator tries to fool the discriminator, while the latter one tries not to be fooled. To generate the best images/results, a very good generator and discriminator are required because, if the generator is bad, it will never be able to fool the discriminator and the underlying machine learning model will never converge. If the discriminator is bad, images/results which make no sense will also be classified as real and, hence, the model never trains and in turn may never produce the desired output.

### SUMMARY

According to one aspect of the present invention, a computer-implemented method for performing an iteration of an output of a trained generator adversarial network may be provided. The method may comprise receiving an object as input for the generator adversarial network, determining a set of features of the input by the generator adversarial network, and generating, by the generator adversarial network, at least one modification to one feature of the set of features of the object.

Furthermore, the method may comprise generating as output of the generator adversarial network the received object as a basis and the generated modification building a modified object, capturing a feedback signal indicative of a reaction to the output of the generator adversarial network, and receiving the feedback signal as input by the generator adversarial network in a feedback loop for a next iteration.

Moreover, the method may further comprise repeating the determination of a set of features, the generation of at least one modification, the generation of the output and the caption of the feedback signal in the next iteration, wherein as object the modified object is used as the object.

According to another aspect of the present invention, a related reaction-enabled digital content creator system for performing an iteration of an output of a trained generator adversarial network may be provided.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain means for storing, communicating, propagating or transporting the program for use, by, or in connection, with the instruction execution system, apparatus, or device.

### BRIEF DESCRIPTION OF THE SEVERAL VIEWS OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above, and further aspects of the present invention, are apparent from the examples of embodiments to be described hereinafter and are explained with reference to the examples of embodiments, but to which the invention is not limited.

Preferred embodiments of the invention will be described, by way of example only, and with reference to the following drawings:

FIG. 1 shows a block diagram of an embodiment of the inventive computer-implemented method for performing an iteration of an output of a trained generator adversarial network.

FIG. 2 shows a block diagram of an architectural overview of building blocks instrumental for an execution of the proposed method, in accordance with the exemplary embodiments.

FIG. 3 shows a block diagram of an embodiment of an inventive reaction-enabled digital content creator system.

FIG. 4 depicts an exemplary block diagram depicting the hardware components of an inventive reaction-enabled digital content creator system.

FIG. 5 depicts a cloud computing environment, in accordance with the exemplary embodiments.

FIG. 6 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION

In the context of this description, the following conventions, terms and/or expressions may be used:

The term ‘generator adversarial network’ (GAN) may denote a machine learning system that comprises two neural networks which compete with each other in a game (in the sense of the concept of game theory, but not always in the form of a zero-sum game). Based on a training data set, the technique used may learn to generate new data with the same statistics as the training set. A generator or generative network may generate candidates while the discriminative network or discriminator evaluates them on a constant basis. The contest may operate in terms of data distributions. Typically, the generative network learns to map from a latent space to a data distribution of interest, while the discriminative network may distinguish candidates produced by the generator from the true data distribution. The generative network's training objective may be to increase the error rate of the discriminative network (i.e., “fool” the discriminator network) by producing novel candidates that the discriminator determines to be not synthesized, i.e., are part of the true data distribution.

It may also be noted that the discriminator component of the GAN may only be used during the training phase of the GAN and not in the productive or operational phase, i.e., the inference phase of the GAN.

The term ‘object’ may denote, in particular, a digital object describing a real word phenomenon, such as a painting or other three-dimensional object. In general, other types of digital content may be coded in the digital object, like text, sound (voice or music) or any other observable real word phenomenon. However, it may be noted that the described technique may best work with images due to quick feedback or reinforcement learning cycles.

The term ‘feature’ may denote a characteristic of the object (i.e., the digital object) which may be described as specific attributes of the object and its related data record.

The term ‘modification to one feature’ may denote that at least one of the attributes describing the feature may be altered. It may relate to, e.g., a position of the feature in a 2D image or a 3D object which may, e.g., be producible and or modifiable by a 3D printer (optionally including a lace or other material decomposition tool). It may also relate to an orientation of the future, its rotation angle, a change in the underlying color space (varying values of the RGB color space), and application of image filters, or any other observable modification of an appearance of the future.

The term ‘feedback signal’ may denote a signal generated by an evaluating entity after receiving an impression of the object, e.g., the image, which may have been produced by the generator component of the GAN. The evaluating entity may, e.g., be a user, inputting his feedback to a receiving system or by measuring a physically determinable reaction of the user. Alternatively, the evaluating entity may be a master system simulating a user's (or a group of users') behavior with certain constraints.

The term ‘feedback loop’ may denote a signal path from the evaluating entity or via the feedback signal through either a optimization loop or, alternatively, through a reinforcement learning agent to influence the functioning of the generator of the trained GAN. This influence may be transformed into a generation of a new modified object (e.g., modified image).

The term ‘master system’ may denote a system integrated into the feedback loop from the generated object back to the functioning of the generator. The master system may be adapted to generate a feedback signal based on the received data record of the object. The master system may be influenced by a set of rules (constant or variable in time) and/or by input of one or more users or other systems.

The term ‘phenomenologically observable variable’ may denote any kind of human reaction to a stimulus, e.g., by seeing an image. It may be a facial expression (i.e., mimic) captured by a face recognition system (differentiating, e.g., between anger, sadness, empathy, compassion, hatred, disgust, fear, curiosity, surprise, anticipation, trust, joy, happiness, satisfaction, etc.), the tone of the voice, blood pressure, heart rate, blood oxygen level, conductivity of the skin, state and posture of the human body, etc. Basically, it may concern every physically measurable reaction to an impression (e.g., audio, visual, sensory) by a user. Alternatively, if the evaluating entity is not a human user, the master system may determine or evaluate how well the object may fit into the surrounding of the object. Parameters for such a determination may be the size, the color, the orientation and any other characteristic of the object (e.g., the image of a 3D object) in comparison to its surrounding. Such a determination may be performed according to a predefined set of rules or based on an independent machine learning system trained to classify a “fit” of the object into its environment.

The term ‘reinforcement learning model’ may denote an approach to machine learning that may enable an agent (i.e., software agent) to learn in an interactive environment by trial and error using feedback from its own output signals, actions, and experiences. Reinforcement learning uses rewards and punishments as signals for positive and negative behavior. Compared to unsupervised learning, reinforcement learning is different in terms of its goals. While the goal of unsupervised learning is to find similarities and differences between data points, in reinforcement learning the goal is to find a suitable action model that would maximize the total cumulative reward of the agent.

The term ‘reward function’ may define how the agent ought to behave. In other words, it has “normative” content, stipulating what the agent shall accomplish. The better the reward function is able to describe the desired goal, the faster the learning process converges not getting stuck in local minima.

The term ‘image’ may denote a digital image describable as data record comprising pixels of the digital image.

The proposed computer-implemented method for performing an iteration of an output of a trained generator adversarial network may offer multiple advantages, contributions and technical effects:

Fundamentally, the proposed concept may allow an adaptation of an appearance of an object, in particular via its digital description, based on measured input data captured from reactions to a modified appearance of the object. Hence, if the object is a digital image and an observer, in particular an evaluating entity in form of a user, looks at the image he may produce a certain reaction. This reaction may be measurable as a feedback value which may be fed back to an optimization algorithm or a reinforcement learning agent into the generative component of the GAN in order to produce immediately another modified object. This process may be repeated until the user, observing the constantly modified object, may be satisfied. The satisfaction may be measurable and may, at the same time, produce the highest determinable reward for the software agent in the feedback loop.

Such a modification process, in particular if the object is an image, may be done in a comparably short amount of time. If, e.g., a user moves into a new apartment and would like to hang an image on a wall, e.g., a painting, using the proposed system an image may be generated and displayed on a screen, then modified until it fits to the user's preference. Once a satisfactory appearance of the image is reached, it may be printed and hung on the wall instead being display on a screen.

The proposed concept may also be applied to 3D objects which may be modifiable using 3D printers. However, such a process may require longer feedback cycles. It may also be envisioned that also complete building architectures may be generated and optimized this way. Such buildings, as well as other 3D objects, may be visualized as a sequence of images (e.g., a “slide show”), each of which may undergo the here proposed method before the complete object may be realized.

It may be noted that the underlying optimization process typically starts with a start object which may be used as the initial point of the optimization.

Furthermore, the proposed concept may also be applicable to the digital content in the form of texts, music, voices, and so on.

The proposed concept may allow replacement of the user by a master system which may react to the new appearance of the object. This reaction may be based on a predefined set of rules, a variable set of rules (e.g., depending on environment conditions), or a trained machine learning system.

In the following, additional embodiments (applicable to the method as well as to the related system) will be described:

According to one permissive embodiment of the method, the feedback signal may originate from a user input signal or a master system. This way, both human intervention in the feedback loop, as well as a supervising system, i.e., a master system operating according to predefined rules or based on a supervising machine learning system, may be used to optimize the functioning of the proposed method and system. In this case, a user's input may be part of the feedback loop, and the operation of the here proposed concept may reflect user individual preferences.

According to one advantageous embodiment of the method, the feedback signal may be related to an auditory, visual, textual, sound, voice tone, and/or phenomenologically observable variable. Thus, any measurable characteristic attribute of a user, such as blood pressure, heart rate, skin resistance and/or temperature, facial expression (e.g., anger, sadness, empathy, compassion, hatred, disgust, fear, curiosity, surprise, anticipation, trust, joy, happiness, satisfaction, etc.) may be used to generate a feedback signal. Generally speaking, any measurable metric of a user's body (including state and posture) may be used. A fitness tracker may be used to capture some of the aforementioned parameter values. Additionally, a camera may observe the user. Furthermore, the user may input any feedback data using an input device.

According to an advanced embodiment of the method, the feedback loop may be instantiated as a reinforcement learning (RL) model or RL system comprising a reward function (controlling the behavior of a software agent) or any other form of optimization algorithm which may be system implementable. Basically, this means that the feedback signal may be used as a state parameter for the reinforcement learning model or loop. In this context, and according to a further developed embodiment of the method, in the feedback loop the reward function (i.e., the output value of the reward function) may be maximized. Hence, successful reinforcement learning techniques may be applied also here as basis of the here proposed concept.

According to one preferably implemented embodiment of the method, the object may be an image (in particular, in a digital representation) and where the set of features may comprise at least one of the group comprising a geometrical form in the image, an orientation of the geometrical form, a color value of the geometrical form, a size of the geometrical form, a position of the geometrical form, pixel density, and a brightness value. Hence, any useful characteristic of the image may be used as a feature in the context of the here proposed concept. This may also be applicable to features that may have no meaning to humans but which may be critical to a GAN, because the generative model learns to map points in the latent space to generated, e.g., images. The latent space has no meaning other than the meaning applied to it via the generative model. Yet, the latent space has a structure that can be explored, such as by interpolating between points and performing vector arithmetic between points in latent space which have meaningful and targeted effects on the generated images.

According to a practical embodiment of the method, the feedback loop may also receive as additional import preference data or profile data, in particular, of a user. This way, the optimization process of the appearance of the object (e.g., the image) may be made user specific. This may also contribute to a fast convergence process of the reinforcement learning loop. The data may have been captured automatically from any data source relating to the user, e.g., a self-generated user profile or extracted from any type of social media or otherwise collected data relating to the user.

According to one useful embodiment of the method, the repeating may be stopped if a stop condition may be met. Such a stop condition may comprise a predefined number of iterations that have been executed, a predetermined time period during which the feedback loop has operated, or when a delta of the reward function value may be smaller than a predefined threshold value, i.e., if a maximum of the reward function (e.g., of the optimization algorithm) has been reached. Generally, any type of stop condition may be used which may also be made dependent on the type of object.

According to a further developed embodiment of the method, the feedback signal may be a function of time varying results of an emotive analysis of a user, or a group of users, observing the object simultaneously. Optionally, the time varying results may undergo an averaging and or normalization function. This way, not only the reaction of a single user may be captured, but also a group of interacting or non-interacting (among them) users may be used to generate the feedback signal for the feedback loop, e.g., the reinforcement learning agent and thus for the generative portion of the GAN.

According to one further enhanced embodiment of the method, the generation of the at least one modification to one feature of the set of features of the object may also comprise determining a harmony factor as a function of an appearance of the object and an appearance of a surroundings of the object. Thus, a “fit” of the generated object (e.g., image or 3D object) to the physical environment in which the generated object is positioned may be determined. Thereby, the harmony factor may be based on a distance function between the appearance of the object in comparison to its environment. This may be based on physical attributes like color, size, orientation, etc.

In the following, a detailed description of the figures will be given. All instructions in the figures are schematic. Firstly, a block diagram of an embodiment of the inventive computer-implemented method for performing an iteration of an output of a trained generator adversarial network is given. Afterwards, further embodiments, as well as embodiments of the reaction-enabled digital content creator system for performing an iteration of an output of a trained generator adversarial network, will be described.

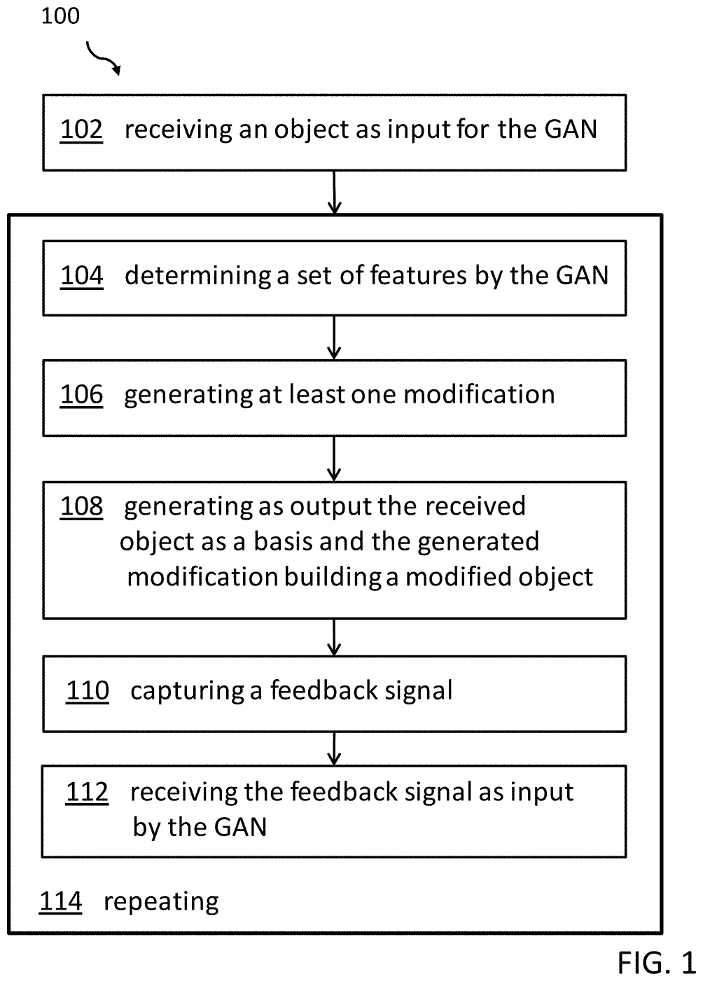

FIG. 1 shows a block diagram of a preferred embodiment of the method 100 for performing an iteration of an output, e.g., in form of an image, of a trained generator adversarial network (GAN). The method 100 comprises receiving, 102, an object as input for the generator adversarial network. The received object may be the starting point for the future modification. This process step may only be required once. In a next process step, a set of features, in particular contextual attributes or real attributes of the input, are determined, 104, by the generator adversarial network by the generative portion of the GAN.

It may be noted that the training of the GAN has been performed before the here proposed method starts.

Furthermore, the method 100 comprises generating, 106, by the GAN, at least one modification to at least one feature of the set of features of the object and generating, 108, as output of the GAN, the received object as a basis and the generated modification building a modified object.

Based on this, the method 100 also comprises capturing, 110, at least one feedback signal to the output of the GAN and receiving, 112, the feedback signal as input by the GAN in a feedback loop for a next iteration.

Furthermore, the method 100 also comprises repeating, 114, the steps of the determination 104 of the set of features, the generation 106 of at least one modification, the generation 108 of the output and the caption 110 of the feedback signal in the next iteration, wherein as object the modified object is used as the object. Thereby the loop from and to the generator of the GAN is closed for a reinforcement learning approach.

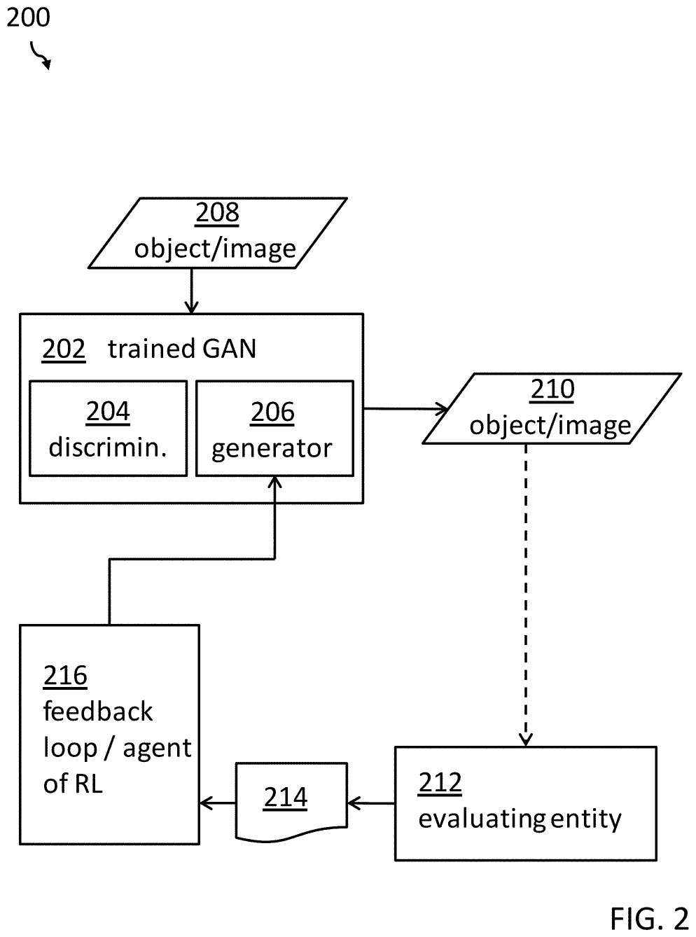

FIG. 2 shows a block diagram of an architectural overview 200 of building blocks instrumental for an execution of the proposed method. One central element is the pre-trained GAN 202. It comprises a discriminator 204, which may only be used during the training process of the GAN 202, and a generator 206. Based on the initially received object or image 208 in form of a digital representation, the generator 206 generates a modified object 210.

This produces a reaction in the evaluating entity 212, e.g., a user. The reaction may be measured in form of auditory, visual, or any other capturable and measurable physical reaction by a face recognition system, a skin resistance measurement unit, a heart rate detector, a blood pressure detector, and/or oxygen level detector, etc. (or a combination thereof). This results in a feedback value 214 which may be used in the feedback loop 216. This may be implemented as an agent of a reinforcement learning system or as another kind of feedback and optimization algorithm. The result of the feedback loop is then fed—in particular via a second receiving unit—to the generator 206, which in turn modifies the object again within its limits of its latency space. The loop can start again. This loop process may continue until a stop condition is met.

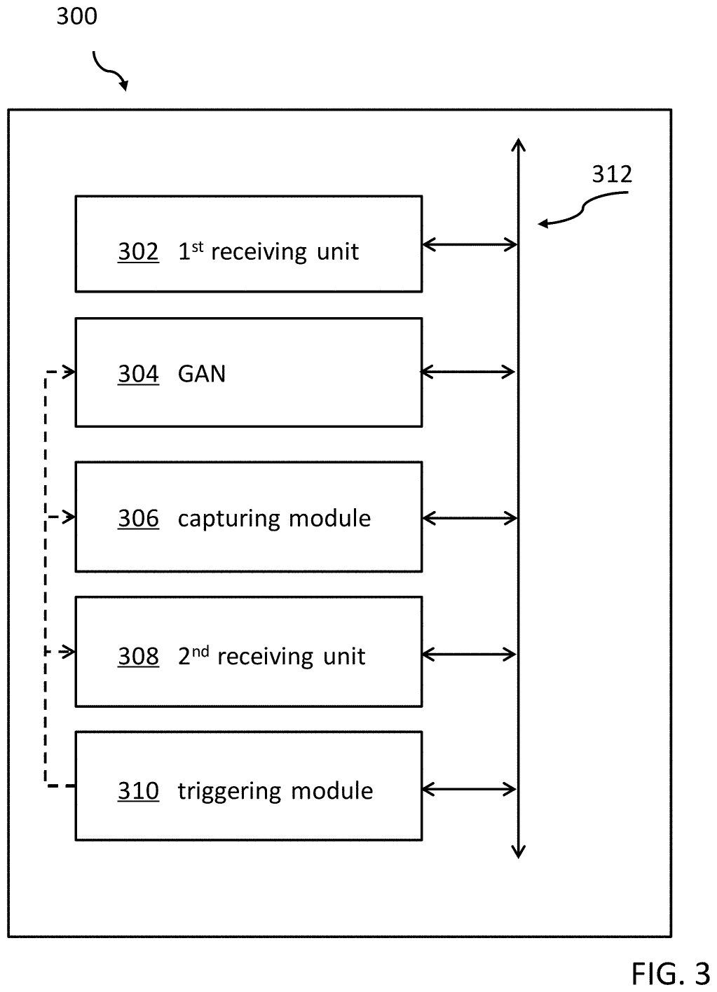

FIG. 3 shows a block diagram of an embodiment of an inventive reaction-enabled digital content creator system 300 for performing an iteration of an output of a trained generator adversarial network. The system 300 comprises first receiving means, namely a first receiving unit 302, adapted for receiving an object as input for the generator adversarial network (GAN) 304. Thereby, the GAN 304 is adapted for determining a set of features of the input. The GAN 304 is also adapted for generating at least one modification to one feature of the set of features of the object, and the GAN 304 is further adapted for generating as output the received object as a basis, and the generated modification thereby building a modified object.

Furthermore, the system 300 comprises capturing means, namely the capturing module 306, adapted for capturing a feedback signal indicative of a reaction to the output of the GAN 304 and second receiving means, namely the second receiving unit 308, adapted for receiving the feedback signal as input by the generator adversarial network in a feedback loop for a next iteration.

The system 300 comprises trigger means, namely the triggering module 310, adapted for triggering the GAN 304 for determining a set of features, the GAN 304 for generating at least one modification, the GAN 306 for generating as output the received object, the capturing unit 306, and the second receiving unit 308. This triggering may be performed, either by a direct link from the triggering module 310 to the other modules and units or via the system internal bus system 312.

It may also be noted that the modules and units used by or being part of the system may be electrically and communicative be coupled in form of a mutual data exchange. This may be implemented as a set of one-to-one connections between the modules and units or via the system-internal bus system 312.

Embodiments of the invention may be implemented together with virtually any type of computer, regardless of the platform being suitable for storing and/or executing program code.

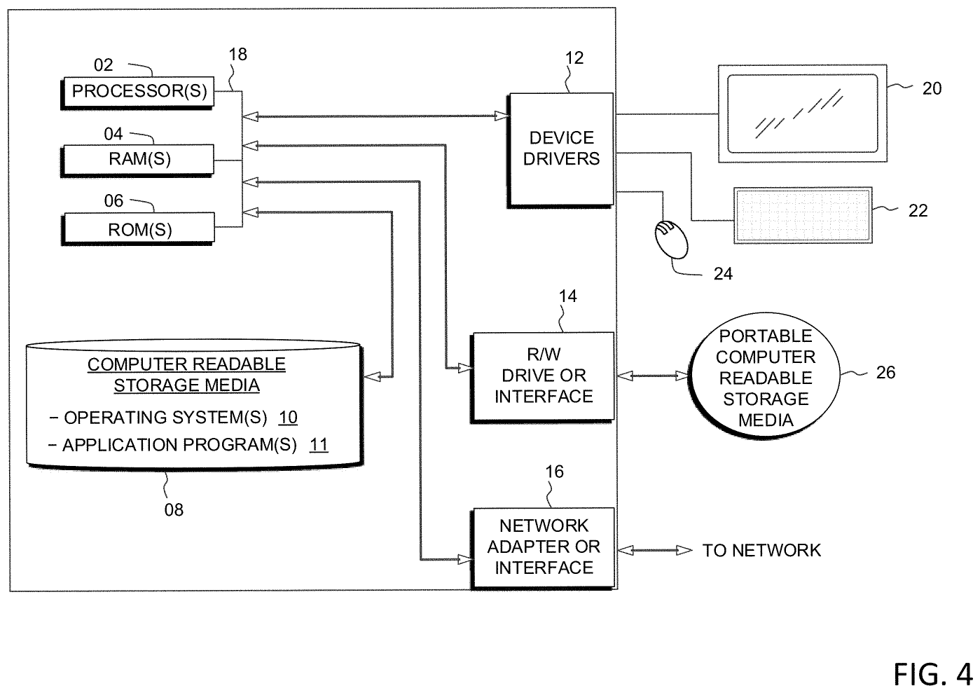

FIG. 4 depicts a block diagram of devices used within the present invention, in accordance with the exemplary embodiments. It should be appreciated that FIG. 4 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail) The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

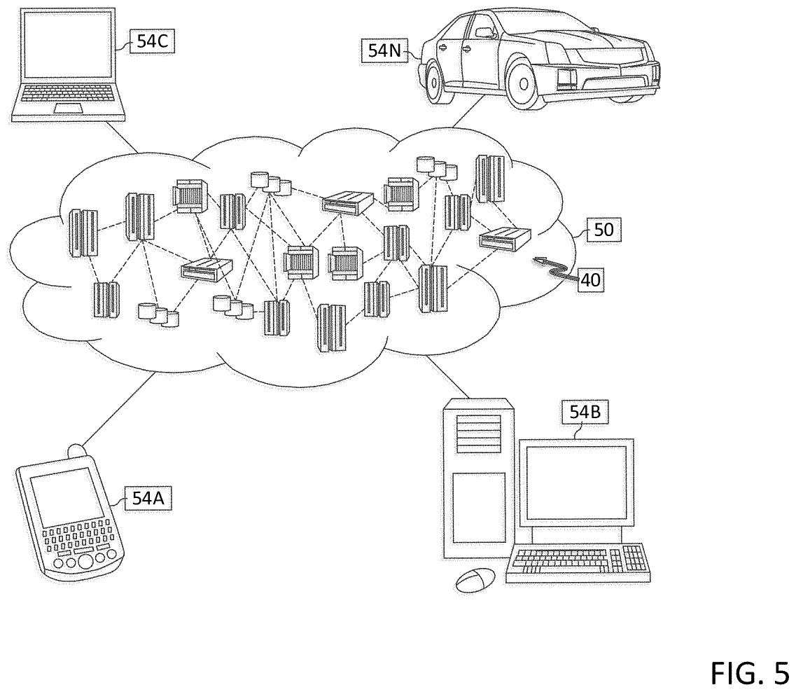

Referring now to FIG. 5, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

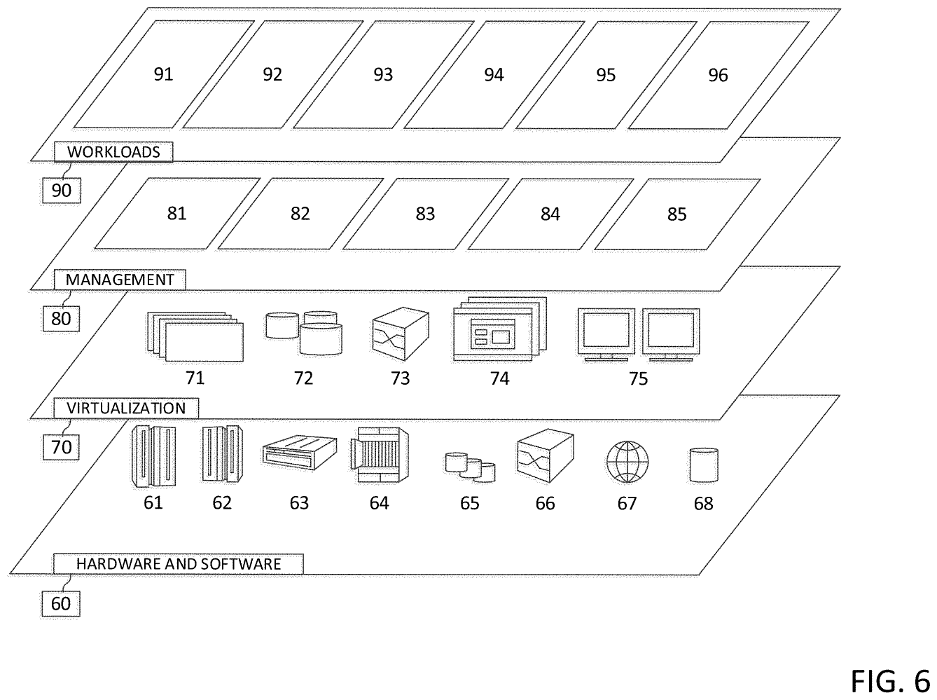

Referring now to FIG. 6, a set of functional abstraction layers provided by cloud computing environment 50 (FIG. 5) is shown. It should be understood in advance that the components, layers, and functions shown in FIG. 6 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and digital content processing 96.

The exemplary embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for performing an iteration of an output of a trained generator adversarial network, the method comprising:
receiving an object as input for the generator adversarial network;
determining a set of features of the input by the generator adversarial network;
generating, by the generator adversarial network, at least one modification to one feature of the set of features of the object;
generating as output of the generator adversarial network, and based on the received object and the generated modification, a modified object;
capturing a feedback signal indicative of a reaction to the output of the generator adversarial network;
receiving the feedback signal as input by the generator adversarial network in a feedback loop for a next iteration; and
repeating the determination of a set of features, the generation of at least one modification, the generation of the output, the capturing of the feedback signal in the next iteration, and receiving the feedback signal as input, wherein the modified object is used as the object.

2. The method according to claim 1, wherein the feedback signal originates from a user input signal or a master system.

3. The method according to claim 2, wherein the feedback signal is related to at least one of an auditory, visual, or textual, phenomenologically observable variable.

4. The method according to claim 1, wherein the feedback loop is instantiated as a reinforcement learning model comprising a reward function or an optimization algorithm.

5. The method according to claim 4, wherein in the feedback loop the reward function is maximized.

6. The method according to claim 1, wherein the object is an image and wherein the set of features comprises at least one of the group comprising a geometrical form in the image, an orientation of the geometrical form, a color value of the geometrical form, a size of the geometrical form, a position of the geometrical form, a pixel density, and a brightness value.

7. The method according to claim 1, wherein the feedback loop also receives preference data or profile data.

8. The method according to claim 1, wherein the repeating is stopped if a stop condition is met, and wherein the stop condition comprises at least one of a predefined number of iterations, a predetermined time period, or a delta of the reward function value is smaller than a predefined threshold value.

9. The method according to claim 1, wherein the feedback signal is a function of time varying results of an emotive analysis of a user, or a group of users, observing simultaneously the object.

10. The method according to claim 1, wherein the generation of the at least one modification to one feature of the set of features of the object further comprises:
determining a harmony factor as a function of an appearance of the object and an appearance of a surrounding of the object.

11. A reaction-enabled digital content creator system for performing an iteration of an output of a trained generator adversarial network, the system comprising:
one or more computer processors, one or more computer-readable storage media, and program instructions stored on the one or more of the computer-readable storage media for execution by at least one of the one or more processors capable of performing a method, the method comprising:
receiving an object as input for the generator adversarial network;
determining a set of features of the input by the generator adversarial network;
generating, by the generator adversarial network, at least one modification to one feature of the set of features of the object;
generating as output of the generator adversarial network, and based on the received object and the generated modification, a modified object;
capturing a feedback signal indicative of a reaction to the output of the generator adversarial network;
receiving the feedback signal as input by the generator adversarial network in a feedback loop for a next iteration; and
repeating the determination of a set of features, the generation of at least one modification, the generation of the output, the capturing of the feedback signal in the next iteration, and receiving the feedback signal as input, wherein the modified object is used as the object.

12. The system according to claim 11, wherein the feedback signal originates from a user input signal or a master system.

13. The system according to claim 12, wherein the feedback signal is related to at least one of an auditory, visual, or textual, phenomenologically observable variable.

14. The system according to claim 11, wherein the feedback loop is instantiated as a reinforcement learning model system comprising a reward function module or an optimization unit.

15. The system according to claim 14, wherein in the feedback loop the reward function is maximized.

16. The system according to claim 11, wherein the object is an image, and where the set of features comprises at least one of the group comprising a geometrical form in the image, an orientation of the geometrical form, a color value of the geometrical form, a size of the geometrical form, a position of the geometrical form, pixel density, and a brightness value.

17. The system according to claim 11, wherein the feedback loop is also adapted for a reception of preference data or profile data.

18. The system according to claim 11, wherein the iteration is stopped if a stop condition is met, wherein the stop condition comprises at least one of a predefined number of iterations, a predetermined time period, or a delta of the reward function value is smaller than a predefined threshold value.

19. The system according to claim 11, wherein the feedback signal is a function of time varying results of an emotive analysis of a user, or a group of users, observing simultaneously the object.

20. A computer program product for performing an iteration of an output of a trained generator adversarial network, the computer program product comprising:
one or more non-transitory computer-readable storage media and program instructions stored on the one or more non-transitory computer-readable storage media capable of performing a method, the method comprising:
receiving an object as input for the generator adversarial network;
determining a set of features of the input by the generator adversarial network;
generating, by the generator adversarial network, at least one modification to one feature of the set of features of the object;
generating as output of the generator adversarial network, and based on the received object and the generated modification, a modified object;
capturing a feedback signal indicative of a reaction to the output of the generator adversarial network;
receiving the feedback signal as input by the generator adversarial network in a feedback loop for a next iteration; and
repeating the determination of a set of features, the generation of at least one modification, the generation of the output, the capturing of the feedback signal in the next iteration, and receiving the feedback signal as input, wherein the modified object is used as the object.
